(19) United States
(12) Patent Application Publication
(10) Pub. No.: US 2008/0110070 A1
(43) Pub. Date: May 15, 2008

(54) Tag Holder with Flexible Thread

(76) Inventor: Mario Mainetti, Vicenza (IT)

Correspondence Address: Bucknam and Archer, 1077 Northern Boulevard, Roslyn, NY, 11576-1696, US

(21) Appl. No.: 11/793,563

(22) PCT Filed: Jan. 11, 2006
(86) PCT No.: PCT/EP06/00151

§ 371 Date: Jun. 19, 2007

(30) Foreign Application Priority Data
Jan. 19, 2005 (IT) V12005A000016

(51) Int. Cl. G09F 3/14

(52) U.S. Cl. 40/642.02

(57) ABSTRACT

This relates to a tag holder with flexible thread, of the type wherein a filiform body composed of a flexible cord, straight or twisted, realized in fabric, in natural fibers such as cotton or linen or in synthetic fibers such as nylon or rayon and where said body is provided at one of its ends with a transverse bar, preferably realized in plastic material, which constitutes the desired attachment ratchet. The terminal portion of the flexible cord is incorporated in the body of the transverse bar (3), arranging itself in a direction substantially coaxial with the longitudinal axis of the bar itself.

The present finding relates to a tag holder with flexible thread.

As is well known, in the commercial field the characteristics and properties of a single object, such as for example the constructor name, the price or composition of the constituent material, are often listed on a tag which accompanies the same product and which is held by a tag holder, which is anchored on the product to be identified.

In particular, in clothing articles, the tag holder is composed of a filiform body, on which the tag is inserted, which has one of its ends anchored in a stable manner on the product to be identified and the other end which holds the product identification tag.

The anchoring of the filiform body on the product is normally realised by providing the end of the body itself with a ratchet composed of a transverse bar, which is introduced into an opening present on the object to be identified and which has a size such to prevent the unthreading from the aforementioned opening.

Such opening may be composed of a hole with small dimensions with respect to the width of the transverse bar or in the case of fabrics or knitwear, of the weave interspace.

In particular, in fabrics and in knitwear articles the anchoring of the tag occurs by inserting the ratchet, composed of a transverse bar, by means of an appropriate tool, with which the transverse bar of the filiform body is positioned on the inner part of the fabric or knitwear.

In both cases, the transverse bar always remains within the object wall, while exiting outward and visible is the entire filiform body, which holds the tag by means of an expansion of its lower end obtained with a knot or through an added plate, which is normally moulded at the same time as the transverse bar by means of in se known processes.

The tag holders of economic type currently present on the market are realised with a moulding operation in which the filiform body, the transverse bar and the terminal expansion (knot or plate) constitute a single element in plastic material.

Alternatively, the tags which must satisfy particular employment or aesthetic needs are composed of a filiform body, composed of a flexible cord, straight or twisted, realised in fabric, in natural fibres such as cotton or linen, in artificial fibres such as nylon, rayon or other material and said body is provided at one end with a transverse bar in plastic material, which constitutes the ratchet.

The area of union of the two components, the same being arranged in mutually perpendicular manner, is of course very small, so that there is the risk that, with a minimal traction stress on the thread, this detaches from the plastic material body which constitutes the ratchet.

In order to obtain a sufficient adhesion between the two components of the tag holder, the mutual connection between the end of the flexible thread and the transverse bar occurs by equipping the bar itself with a shank, which permits burying in the plastic mass a not negligible portion of the thread end, with respect to the simple intersection or superimposition of the two aforementioned components.

In practice, therefore, the ratchet in plastic material assumes a “T” conformation, from the base of which the flexible thread departs, realised in fabric by means of natural or artificial fibres.

Such configuration, described in the patent documents GB 2359853 and GB 2389388, has at least two drawbacks.

A first drawback is due to the fact that a complex moulding work is required to position and maintain in position the flexible thread within the mould during the moulding of the plastic “T”-shaped ratchet.

A second drawback derives from the fact that, when the tag is hung on the product to be labelled, a part of the plastic “T”-shaped ratchet, in particular the section which holds the flexible thread in the case, for example, of very thin fabrics, may project externally, getting caught on and possibly damaging other products, or it may generate a negative aesthetic effect when, for example, the tag is applied on very refined clothing articles, where every minimal detail contributes to distinguish their quality.

Object of the present finding it that of realising a tag holder of two components, i.e. of the type which comprises a flexible thread in a different material from that of the transverse bar of the ratchet, which lacks the drawbacks manifested by similar products of known type.

Such object is obtained with a tag holder of two components, realised with different materials, of the type where the ratchet is composed of bar applied transversely to an end of the flexible thread, which is characterised in that the terminal portion of the flexible thread is incorporated in the body of the bar and arranged with a substantially coaxial direction with the longitudinal axis of the bar itself.

Practically, during the moulding of the bar, the terminal part of the flexible thread is buried in the plastic mass, for a part which corresponds to approximately half of the length of the aforementioned bar.

In such a manner, once moulding is completed, a tag holder is obtained composed of a plastic bar from which the flexible thread exits, in preferably central position as in the most common realisations but where, operatively, there is the advantage that the flexible thread is considerably more resistant to tearing, thanks to its considerable portion buried in the plastic mass.

The tag holder will be advantageously completed with the moulding of a terminal plate in plastic material, incorporating the terminal part of the flexible thread, with the function of holding the tag anchored to the object/product or fabric.

Finally, the finding foresees, still advantageously, that the filiform bodies of the tag holders are held in superimposed manner by means of a rigid frame, realised simultaneously with the moulding of the aforementioned bodies.

This rigid frame binds a plurality of tag holders arranged in a stack, in an ordered and spaced manner, which may be applied to objects to be labelled by utilising common tools present on the market.

The finding will be better understood by means of the description of one of its possible embodiments, given only as a not limiting example, with the aid of the attached drawings, wherein:

FIG. 1 represents a tag holder according to the finding;

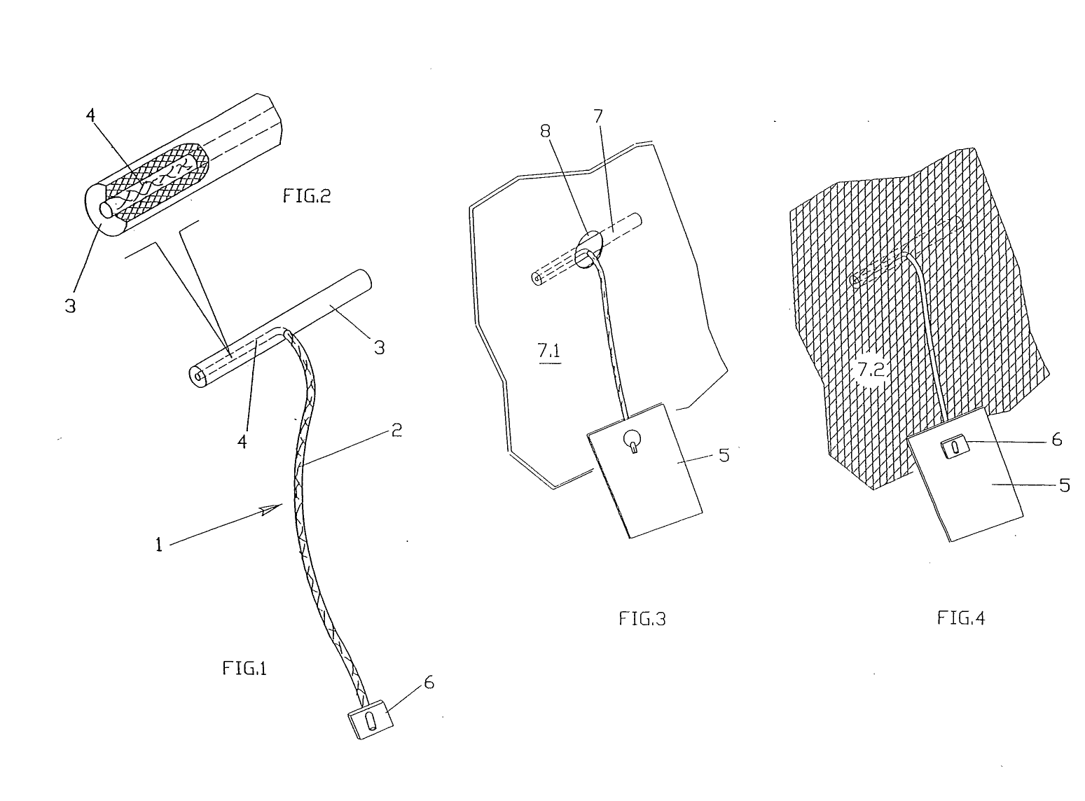

FIG. 2 represents a detail cutaway view of the transverse bar;

FIGS. 3 and 4 represent the tag holder of FIG. 1, in operative condition, respectively applied on a stiff surface or on a fabric;

FIG. 5 (Table II) represents a perspective view of a stack of tag holders held by a little frame;

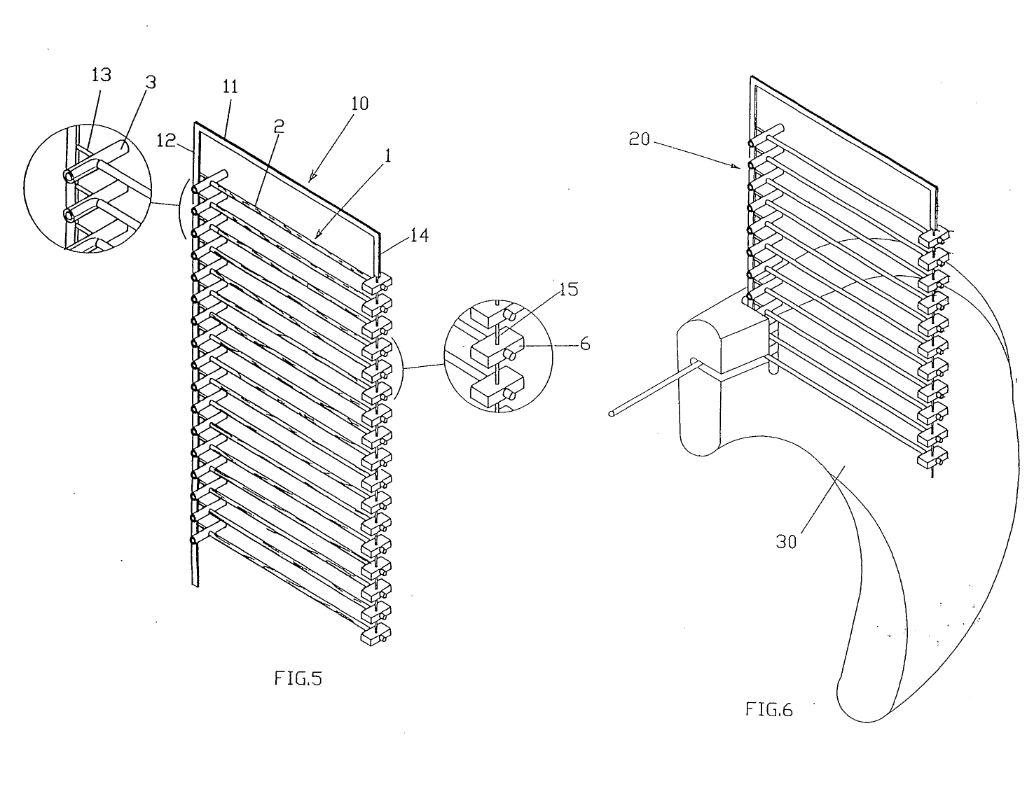

FIG. 6 represents the stack of tag holders mounted on the tag holders' attachment tool.

As may be seen in FIG. 1, the tag holder according to the finding, indicated in its entirety with the number 1, is composed of a flexible thread 2, provided at one of its ends with a transversely-arranged bar 3.

As is visible in FIG. 2, the terminal part 4 of the flexible thread 2 is buried within the bar 3 for at least one half of its length, before exiting from the aforementioned with the remaining part of said thread.

The tag 5 is inserted on the tag holder 1, and in order to avoid unthreading the tag is held by a simple knot or through the application of a plate 6 generally obtained by moulding at the same time as the moulding of the bars 3 on the thread 2, by known processes and means.

In the operative step, as is visible in FIG. 3, the tag holder 1 is applied on the product 7.1, composed of a rigid body, by introducing the bar 3 into the opening 8 so that when it is placed on the inner part of the aforementioned, having a larger size with respect to the profile of the the small frame 10 in order to apply them on the product to be identified.

Different embodiments are of course possible regarding the flexible thread and the transverse bar, without departing from the scope of the following claims.

1. Tag holder with flexible thread, of the type which comprises a filiform composed of a flexible cord, straight or twisted, realized in fabric, in natural fibres such as cotton or linen or in synthetic fibres such as nylon or rayon and where said body is provided at one of its ends with a transverse bar, preferably realized in plastic material, which constitutes the desired attachment ratchet,
said tag holder (1) comprising a terminal portion of the flexible thread (2) incorporated in the body of the transverse bar (3), arranging itself with a direction substantially coaxial with the longitudinal axis of the bar itself.

2. Tag holder with flexible thread, according to claim 1, which comprises a flexible thread (2), provided at one of its ends with a transversely-arranged bar (3), wherein the terminal part (4) of the flexible thread is buried within the bar (3) for at least one half of its length, before exiting from the aforementioned with the remaining part of said thread.

3. Tag holder with flexible thread, according to claim 1, wherein it is bound to a sufficiently rigid small frame (10) such to hold the tag holder so that the flexible thread (2) remains substantially taut.

4. Tag holder with flexible thread, according to claim 3, wherein it is connected to the small frame (10), composed of an upper bar (11) arranged in line with the underlying tag holders (1) and provided with two side rods (12, 14), by means of the pin (13), which holds the bar (3), and by means of the appendage (15), which holds the end plate (6).

5. Tag holders with flexible thread, according to claim 1 wherein they are arranged mutually superimposed or held by a single small frame (10) so to constitute a feeder to be inserted in the employment device (30).

6. Feeder of tag holders with flexible thread, of the type described in claim 5, wherein it is obtained with a single moulding operation which simultaneously realizes the bars (3), the plates (6) and the small frame (10).
